(19) United States
(12) Patent Application Publication
(10) Pub. No.: US 2011/0084474 A1
(43) Pub. Date: Apr. 14, 2011

(54) HIGH RETENTION MAGNETIC COUPLING DEVICE FOR CONDUIT ATTACHMENT

(76) Inventors: David B. Paden, Goleta, CA (US); Josiah E. Verkaik, Lompoc, CA (US)

(21) Appl. No.: 12/996,045

(22) PCT Filed: Jun. 24, 2009
(86) PCT No.: PCT/US2009/048477

§ 371 Date: Dec. 3, 2010

Related U.S. Application Data
(60) Provisional application No. 61/075,545, filed on Jun. 25, 2008.

(51) Int. Cl. F16L 47/10

(52) U.S. Cl. 285/9.1

(57) ABSTRACT

A magnetic coupling having two or more elements for providing a conduit. The coupling provides high retention of conduit elements with minimum size magnetic components, while also providing for intentional detachment of the magnetically coupled elements. The coupling is configured to facilitate detachment with applied loads that are substantially less than operational retention force (i.e., breakaway force) of the magnetically coupled elements. The magnetic coupling device includes a connecting male element and a female element and at least one internal conduit integral to at least one of the connecting male and female elements. Magnetic attraction is accomplished via a magnetic circuit where the magnetic circuit includes ferromagnetic material and at least one permanent magnet.

### CROSS REFERENCE TO RELATED APPLICATIONS

This application claims the benefit of priority of U.S. Provisional Patent Application No. 61/075,545 filed on 25 Jun. 2008, which is incorporated herein by reference.

### FIELD OF THE INVENTION

The present invention relates generally to a magnetic coupling for the attachment of a male and female element for attachment of hollow conduit. More particularly, the invention relates to a magnetic coupling adapted for providing high retention in providing a low impedance flux path of a substantially closed loop at the coupling interface. A primary application of the invention is for facilitating the coupling of a hollow conduit for flow transfer from a first element to a second element.

### BACKGROUND OF THE INVENTION

Many types of couplings that rely on mechanical attachment especially as used for fluid transfer from one element to another are known in the art. However the use magnets to maintain conduit attachment has been limited on account of several factors including the availability and cost of magnets, the field carrying capacity of magnetic materials, and the limitations associated with the size of magnetic elements that would be required for providing sufficient retention force to maintain attachment under operational loading conditions including fluid pressurization.

Moreover, if a magnetic conduit attachment device has a sufficient field as necessary for conduit retention force, this same retention force is necessary to be applied for detachment of the magnetically affixed elements. Since the coupling device would be adapted for high retention as required for the operational parameters of the conduit coupling device, the detachment force required would be excessive for deliberate quick detachment of the magnetically linked elements.

It is, therefore, desirable to provide a mechanism directed toward overcoming the limitations associated with utilizing a magnetic circuit (i.e., magnetic attraction) to facilitate the attachment of two or more elements for providing a conduit.

### SUMMARY OF THE INVENTION

It is an object of the present invention to obviate or mitigate at least one disadvantage of previous magnetic couplings. Moreover, the present invention is directed toward overcoming the limitations associated with utilizing a magnetic circuit (i.e., magnetic attraction) to facilitate the attachment of two or more elements for providing a conduit. According to this aim, the invention provides the basis for high retention, with minimum size magnetic components while also providing means for intentional detachment of the magnetically coupled elements that facilitate detachment with applied loads that are substantially less than operational retention force (i.e., breakaway force) of the magnetically coupled elements

The present invention discloses a high-retention magnetic coupling device for providing at least one conduit. In the broadest sense, magnetic coupling device includes: a connecting male element and a female element and at least one internal conduit integral to at least one of the connecting male and female elements; the male element including an anterior end and a posterior end; the anterior end of the male element including a first magnetic armature; the first magnetic armature including at least one magnetic material forming a substantially closed ring around the periphery of the at least one conduit; the female element including an anterior end and a posterior end; the anterior end including of the female element including a second magnetic armature near the anterior end; the second magnetic armature including at least one magnetic material forming a substantially closed ring around the periphery of the at least one conduit; the anterior ends of the male element and the female element being adapted for interfitting in a plug and socket type arrangement whereas the first magnetic armature is magnetically attracted to the second magnetic armature when the anterior end of the male element is fitted within the anterior end of the female element; the first magnetic armature and the second magnetic armature adapted to attract together by form a magnetic circuit; the magnetic circuit including ferromagnetic material and at least one permanent magnet.

Preferably, the male and female elements of the coupling device include permanent magnets and ferromagnetic material to form a substantially closed-loop low-impedance flux path when the coupling is joined.

The present invention has multiple formats and applications. The magnetic coupling device is adapted to provide a conduit for the transfer of mass from one element to another. In a preferred embodiment the magnetic coupling device can be used for connecting a fluid conduit for fluid communication between tubes or other flow path components such as a pump. Alternatively the coupling device may be adapted for transfer of solid particles of various sizes, a gas, or a vacuum.

According to another aspect of the invention, the coupling device is adapted for transfer of an object such that the provided conduit is essentially an access channel such as, for example, the coupling of a conduit to a surgical instrument in the case of minimally-invasive surgery.

In addition to providing a transfer lumen from one element to another, the conduit provided by the present invention can be adapted for providing a cover or sheath over an elongated object such as a sensor or probe.

The invention as disclosed enables a high degree of miniaturization while also providing high retention force between a male and female element. The arrangement of magnetic material provides maximum retention with minimum loss of magnetic flux as a stray field. That is, according to a preferred embodiment, the magnetic flux is contained whereas substantially no field is present on the outside of the device when the male and female elements are attached. The absence of a significant external magnetic field prevents unwanted interaction of the coupling device with outside structures.

Preferably the magnetic coupling device includes removal means to facilitate detachment with applied loads that are substantially smaller than the high retention force associated with the coupling attachment.

According to one preferred embodiment of the invention, a detachable segmented collar, split into two or more ring segments, is provided as removable from the male or female element for allowing the gradual removal of magnetic material from the magnetic circuit whereby the substantially closed flux path of the coupling is gradually opened to the extent that the breakaway force of the magnetic coupling has been dramatically reduced.

According to another preferred embodiment the male and female elements are adapted for receiving the operative end of a pry/wedge tool accessory near the parting surfaces whereas the pry/wedge tool accessory provides a moment arm for enabling a person to more easily overcome the breakaway of the magnetic coupling by applying a lesser force to the handle end of a pry/wedge tool accessory.

The magnetic coupling device according to the present invention is directed towards having the following advantages.
High-retention/breakaway force
Controlled breakaway at a desired force or pressure
Facilitates miniaturization
Comprises no mechanical locking means which could wear out or jam
Minimal axial length required for coupling (without latches, nuts and other moving parts)
Quick-connect attachment
Blind (self-directed) attachment via magnetic attraction
Characterized with no stray field when assembled
Facilitates a fixed radial orientation via mechanical means
Self-directed radial orientation via magnetic means
Provides for detachment via forces substantially lower than operational breakaway force
Can be adapted for various types of coupling devices including at least one conduit

Other advantages and benefits may be possible, and it is not necessary to achieve all or any of these benefits or advantages in order to practice the invention as claimed. Therefore, nothing in the forgoing description of the possible or exemplary advantages and benefits can or should be taken as limiting the intended scope of the present invention.

### BRIEF DESCRIPTION OF THE DRAWINGS

The novel features of the present invention, which are considered as characteristic for the invention, are set forth with particularity in the appended claims. The invention itself, however, both as to organization and methods of operation, together with further objects and advantages thereof, may best be understood by reference to the following description, taken in conjunction with the accompanying drawings in which:

FIGS. 1A-1C are perspective, elevation, and cross-sectional views respectively that illustrate a male element according to the first preferred embodiment of the present invention.

FIGS. 2A-2C are perspective, elevation, and cross-sectional views respectively that illustrate a female element according to the first preferred embodiment of the present invention.

FIGS. 3A-3B are elevation, and cross-sectional views respectively that illustrate attachment of the male and female elements according to the first preferred embodiment of the present invention.

FIGS. 4A-4C are perspective, elevation, and cross-sectional views respectively that illustrate a male element according to the second preferred embodiment of the present invention.

FIGS. 5A-5C are perspective, elevation, and cross-sectional views respectively that illustrate a female element according to the second preferred embodiment of the present invention.

FIGS. 6A-6B are elevation, and cross-sectional views respectively that illustrate attachment of the male and female elements according to the second preferred embodiment of the present invention.

FIGS. 7A-7C are perspective, elevation, and cross-sectional views respectively that illustrate a male element according to the third preferred embodiment of the present invention.

FIGS. 8A-8C are perspective, elevation, and cross-sectional views respectively that illustrate a female element according to the third preferred embodiment of the present invention.

FIGS. 9A-9B are elevation, and cross-sectional views respectively that illustrate attachment of the male and female elements according to the third preferred embodiment of the present invention.

FIGS. 10A-10C are perspective, elevation, and cross-sectional views respectively that illustrate a male element according to the fourth preferred embodiment of the present invention.

FIGS. 11A-11C are perspective, elevation, and cross-sectional views respectively that illustrate a female element according to the fourth preferred embodiment of the present invention.

FIGS. 12A-12B are elevation, and cross-sectional views respectively that illustrate attachment of the male and female elements according to the fourth preferred embodiment of the present invention.

FIGS. 13A-13C are perspective, elevation, and cross-sectional views respectively that illustrate a male element according to the fifth preferred embodiment of the present invention.

FIGS. 14A-14C are perspective, elevation, and cross-sectional views respectively that illustrate a female element according to the fifth preferred embodiment of the present invention.

FIGS. 15A-15B are elevation, and cross-sectional views respectively that illustrate attachment of the male and female elements according to the fifth preferred embodiment of the present invention.

FIGS. 16A-16C are perspective, elevation, and cross-sectional views respectively that illustrate a male element according to the sixth preferred embodiment of the present invention.

FIGS. 17A-17C are perspective, elevation, and cross-sectional views respectively that illustrate a female element according to the sixth preferred embodiment of the present invention.

FIGS. 18A-18B are elevation, and cross-sectional views respectively that illustrate attachment of the male and female elements according to the sixth preferred embodiment of the present invention.

FIGS. 19A-19C are perspective, elevation, and cross-sectional views respectively that illustrate a male element according to the seventh preferred embodiment of the present invention.

FIGS. 20A-20C are perspective, elevation, and cross-sectional views respectively that illustrate a female element according to the seventh preferred embodiment of the present invention.

FIGS. 21A-21B are elevation, and cross-sectional views respectively that illustrate attachment of the male and female elements according to the seventh preferred embodiment of the present invention.

FIGS. 22A-22C are perspective, elevation, and cross-sectional views respectively that illustrate a male element according to the eighth preferred embodiment of the present invention.

FIGS. 23A-23C are perspective, elevation, and cross-sectional views respectively that illustrate a female element according to the eighth preferred embodiment of the present invention.

FIGS. 24A-24B are elevation, and cross-sectional views respectively that illustrate attachment of the male and female elements according to the eighth preferred embodiment of the present invention.

FIGS. 25A-25C are perspective, elevation, and cross-sectional views respectively that illustrate a male element according to the ninth preferred embodiment of the present invention.

FIGS. 26A-26C are perspective, elevation, and cross-sectional views respectively that illustrate a female element according to the ninth preferred embodiment of the present invention.

FIGS. 27A-27B are elevation, and cross-sectional views respectively that illustrate attachment of the male and female elements according to the ninth preferred embodiment of the present invention.

FIGS. 28A-28C are perspective, elevation, and cross-sectional views respectively that illustrate a male element according to the tenth preferred embodiment of the present invention.

FIGS. 29A-29C are perspective, elevation, and cross-sectional views respectively that illustrate a female element according to the tenth preferred embodiment of the present invention.

FIGS. 30A-30B are elevation, and cross-sectional views respectively that illustrate attachment of the male and female elements according to the tenth preferred embodiment of the present invention.

FIGS. 31A-31C are perspective, elevation, and cross-sectional views respectively that illustrate a male element according to the eleventh preferred embodiment of the present invention.

FIGS. 32A-32C are perspective, elevation, and cross-sectional views respectively that illustrate a female element according to the eleventh preferred embodiment of the present invention.

FIG. 33 is a cross-sectional view that illustrates attachment of the male and female elements according to the eleventh preferred embodiment of the present invention.

FIGS. 34A-34C are perspective, elevation, and cross-sectional views respectively that illustrate a female element according to the twelfth preferred embodiment of the present invention.

FIGS. 35A-35C are perspective, elevation, and cross-sectional views respectively that illustrate a male element according to the twelfth preferred embodiment of the present invention.

FIG. 36A is an elevation views that illustrates attachment of the male and female elements according to the twelfth preferred embodiment of the present invention.

FIG. 36B is a cross-sectional view taken along respective section line of FIG. 36A.

FIG. 36C is a partial cross-sectional exploded detail view taken along respective section line of FIG. 36A.

FIGS. 37A-37B are elevation and cross-sectional views respectively that illustrate a male element according to the thirteenth preferred embodiment of the present invention.

FIGS. 38A-38B are elevation and cross-sectional views respectively that illustrate a female element according to the thirteenth preferred embodiment of the present invention

FIGS. 39A-39B are elevation, and cross-sectional views respectively that illustrate attachment of the male and female elements according to the thirteenth preferred embodiment of the present invention.

FIG. 40 is a perspective view that illustrates a prying tool accessory according to the thirteenth preferred embodiment of the present invention.

FIG. 41A is an elevation view that illustrates the prying tool accessory inserted between the attached male and female elements according to the thirteenth preferred embodiment of the present invention.

FIG. 41B is a cross-sectional view taken along the respective section line of FIG. 41A.

### DETAILED DESCRIPTION

As utilized herein, terms such as “about”, “approximately”, “substantially” and “near” are intended to allow some leeway in mathematical exactness to account for tolerances that are acceptable in the trade as should be understood by one of ordinary skill in the art.

Before explaining the present invention in detail, it should be noted that the invention is not limited in its application or use to the details of construction and arrangement of parts illustrated in the accompanying drawings and description. The illustrative embodiments of the invention may be implemented or incorporated in other embodiment, variations and modifications, and may be practiced or carried out in various ways. Furthermore, unless otherwise indicated, the terms and expressions employed herein have been chosen for the purpose of describing the illustrative embodiments of the present invention and are not for the purpose of limiting the invention. Further it is understood that any one or more of the following-described embodiments, expressions of embodiments, examples, methods, etc. can be combined with any one or more of the other following—described embodiments, expressions or embodiments, examples, methods, etc.

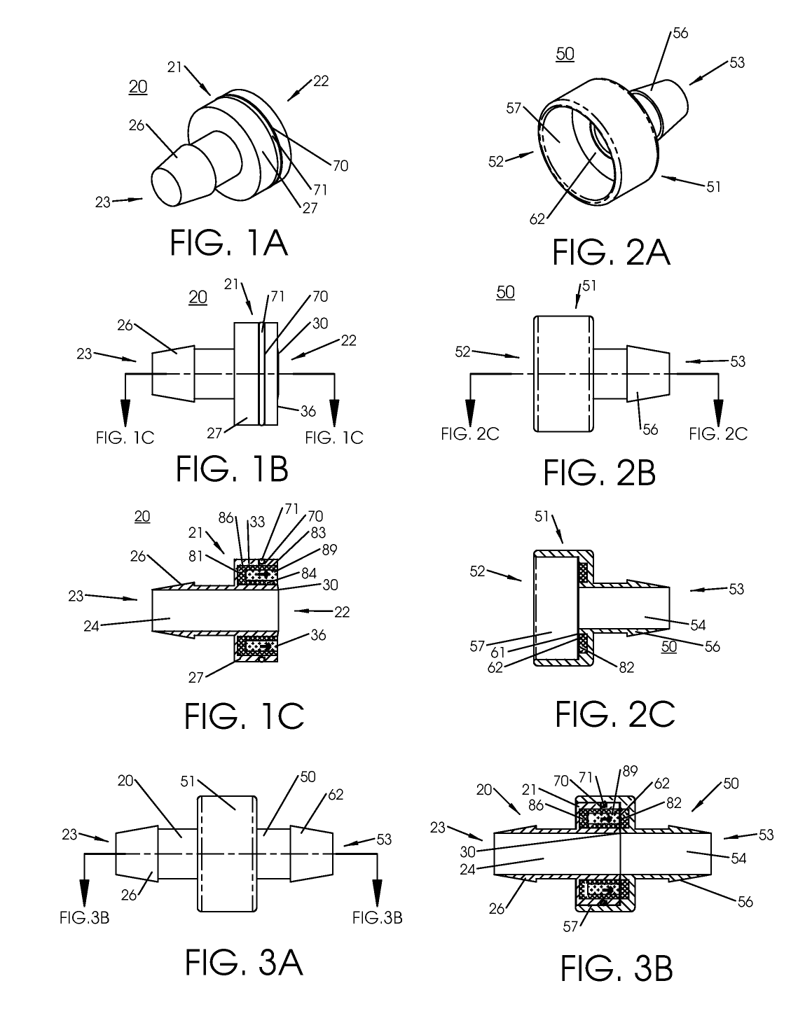

Referring to FIGS. 1A-3B, a first preferred embodiment of a magnetic coupling device according to present invention is shown. FIGS. 1A-1C shows a male element 20, FIGS. 2A-2A shows a female element 50 and FIGS. 3A-3B shows both male element 20 and female element 50 in an attached configuration according to this first preferred embodiment. Male element 20 and female element 50 provide conduit 24 and conduit 54 respectively so that when coupled together, conduit 24 and conduit 54 form hollow internal passage from posterior end 23 of male element 20 to posterior end 53 of female element 50. Male element 20 and female element 50 fit together in a plug and socket type configuration at anterior end 22 and anterior end 52 respectively. According to this configuration male element 20 and female element 50 each include barb fitting 26 and barb fitting 56 at posterior end 23 and posterior end 53 respectively.

The coupling device according to this first preferred embodiment discloses barb fittings at the posterior ends of the male and female elements for the purpose of providing a coupling of tubes or hollow passage way for fluid or other media. Another type of fitting, such as a pipe, compression, lure, through-wall, or other type of known fittings typical of a flow path may be practiced with respect to the invention. Alternatively one or both posterior ends of male and female element may be integral to housing for elements within a flow system such as for example, in the case of liquid transport, pumps, filters, valves, heat exchangers, tank fittings, or other types of equipment widely applied to flow systems.

According to this first preferred embodiment, male element 20 includes plug member 27 and female element 50 includes receiving cavity 57 which is adapted to receive plug member 27. O-ring groove 70 is displaced on plug member 27 and accommodates o-ring seal 71 for providing a liquid tight seal when fitted within receiving cavity 57 of female element 50. In this case plug member 27 of male element 20 is displaced on the outer cylindrical surface of male armature 21. With respect to female element 50, receiving cavity 57 extends from female armature 51 in the anterior direction for receiving anterior end of male element 20. When attached, parting surface 36 of male element 20 is brought into close proximity with parting surface 61 of female element 50. Protective layer 62 of female element 50 provides protection to front ferromagnetic ring 82. In the assembled configuration of FIG. 3B, close spacing of male armature 21 with female armature 51 is provided as shown. Leading edge 30 is provided on anterior end of male element 20 to ensure minimal interruption between conduit 24 and conduit 54 when coupled together.

According to the invention male armature 21 and female armature 51 each contain one or more magnetic rings which combine to form a magnetic circuit and secure male element 20 and female element 50 when anterior end 22 and anterior end 52 are fitted together in close proximity. In each case magnetic attraction is facilitated by at least one permanent magnetic material in the form of a hollow ring or series of rings and additional ferromagnetic, or magnetically susceptible material also in the cross-section of a hollow ring or series of rings that when combined together form a magnetic flux path of a substantially closed loop.

According to this first preferred embodiment, male armature 21 of male element 20 includes central permanent magnet ring 89 and that is surrounded on three sides by back ferromagnetic ring segment 81, outer ferromagnetic ring segment 83 and inner ferromagnetic ring segment 84. Female armature 51 of female element 50 includes front ferromagnetic ring segment 82 at parting surface 61. Preferably back ferromagnetic ring segment 81, outer ferromagnetic ring segment 83, inner ferromagnetic ring segment 84 and central permanent magnet ring 89 are permanently affixed within pocket 33 of male armature 21 such that it is enclosed within male armature 21 on three sides to provide security to the magnetic materials. Preferably front ferromagnetic ring segment 82 is permanently affixed within female armature 51 such that it is housed within a pocket for security and insulation from a chemical environment. Although not shown a thin layer of protective material is preferably displaced on parting surface 36 and protective layer 62 of male element 20 and female element 50 respectively to protect magnetic materials from mechanical and chemical deterioration. Such a protective layer 62 could be a coating or a thin plate which is bonded over the otherwise exposed permanent magnet and ferromagnetic materials of the coupling device.

As shown in the assembled cross-sectional view of FIG. 3B. When male element 20 is fitted within female element 50, central permanent magnet ring 89 is surrounded on four sides with ferromagnetic material. As central permanent magnet ring 89 is magnetized in a the axial direction, flux enters front ferromagnetic ring segment 82 and is directed back around through outer ferromagnetic ring segment 83 and inner ferromagnetic ring segment 84 to 86 providing low-impedance magnetic flux path of a substantially closed loop. Preferably the cross-sectional dimensions and magnetic properties of the ferromagnetic rings are selected so that they are sufficiently sized as to not be magnetically saturated when in the close proximity to the field created by central permanent magnet ring 89. As the configuration of this first preferred embodiment enables substantially all of the flux of central permanent magnet ring 89 to be directed into front ferromagnetic ring segment 82 and back through outer ferromagnetic ring segment 83 and inner ferromagnetic ring segment 84, an attractive force applied to back ferromagnetic ring segment 81 via front ferromagnetic ring segment 82 is maximized and male element 20 maintains coupling to female element 50 under relatively strong magnetic retention. The resultant breakaway force, which is the force required to overcome the magnetic circuit, is much higher than if only front ferromagnetic ring segment 82 was provided with back ferromagnetic ring segment 81, outer ferromagnetic ring segment 83 and inner ferromagnetic ring segment 84 omitted.

Providing the magnetic flux conducting material on three or four sides thus provides maximum retention strength while also being characterized with little flux leakage in the assembled configuration. In this regard, the novel invention also reduces the chance of unwanted magnetic interaction with exterior structures and devices. The substantially closed magnetic circuit also substantially prevents unwanted magnetic interaction with the conduit and that which is being passed through it.

As illustrated in FIGS. 3A and 3B the cross-sectional area needed to facilitate the magnetic coupling and interface of male element 20 with female element 50 is minimal with no extra size that would typically be associated with mechanical attachment involving additional moving parts and interlocking structures. This is especially critical where miniature size is necessary. Additionally, the novel invention provides a high-retention coupling free from pivoting arms and springs typical of mechanical components that could wear out, break, or jam through extended use. Moreover, the invention provides a means of quick connect and disconnect whereas a person need not be concerned with tightening a nut, properly twisting the coupling or actuating a button or lever.

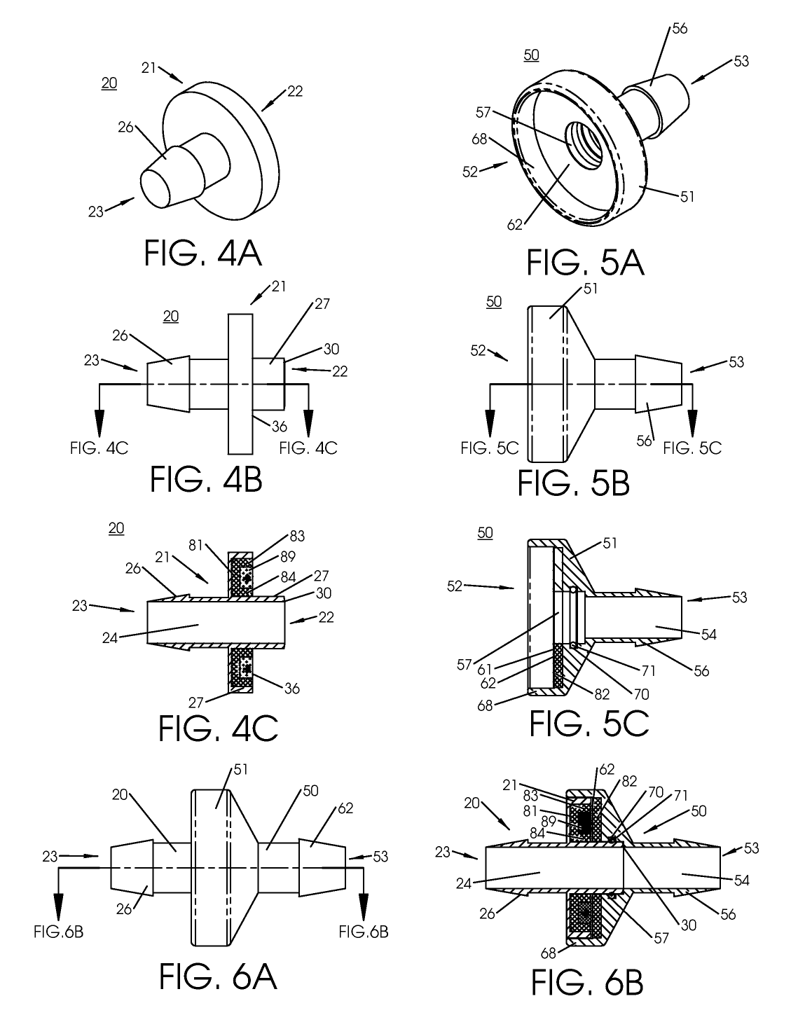

Shown in FIGS. 4A-6B, a second preferred embodiment of the present invention is illustrated. FIGS. 4A-4C illustrates male element 20, FIGS. 5A-5C, illustrates female element 50, and FIGS. 6A-6B shows male element 20 and female element 50 in an attached configuration according to this second preferred embodiment. This second preferred embodiment maintains much of the same nomenclature as the first.

The second preferred embodiment is quite similar to the first with the difference being the design of the plug and socket type interface. In this case plug member 27 of male element 20 is at anterior end 22 and extends axially beyond male armature 21. Female element 50 is adapted to receive plug member 27 within receiving cavity 57 wherein o-ring groove 70 with o-ring seal 71 is displaced to seal against plug member 27 of male element 20. Shroud portion 68 covers male armature 21 when the coupling is assembled as before. However, in this case, shroud portion 68 is not one and the same with receiving cavity 57. Accordingly, the invention preferably provides a seal on either male element 20 or female element 50 with the option of multiple interfacing cylindrical surfaces as the male element 20 and female element 50 fit together.

A distinct advantage to the second preferred embodiment is that o-ring groove 70 need not be displaced on outside of male armature 21 which allows female armature 51 to assume a lower profile with a lesser major diameter or (as shown) permits back ferromagnetic ring segment 81, front ferromagnetic ring segment 82, outer ferromagnetic ring segment 83, inner ferromagnetic ring segment 84 and central permanent magnet ring 89 to assume a greater cross-sectional area with the same corresponding major diameter and thus facilitates a higher retention force as compared to the first preferred embodiment.

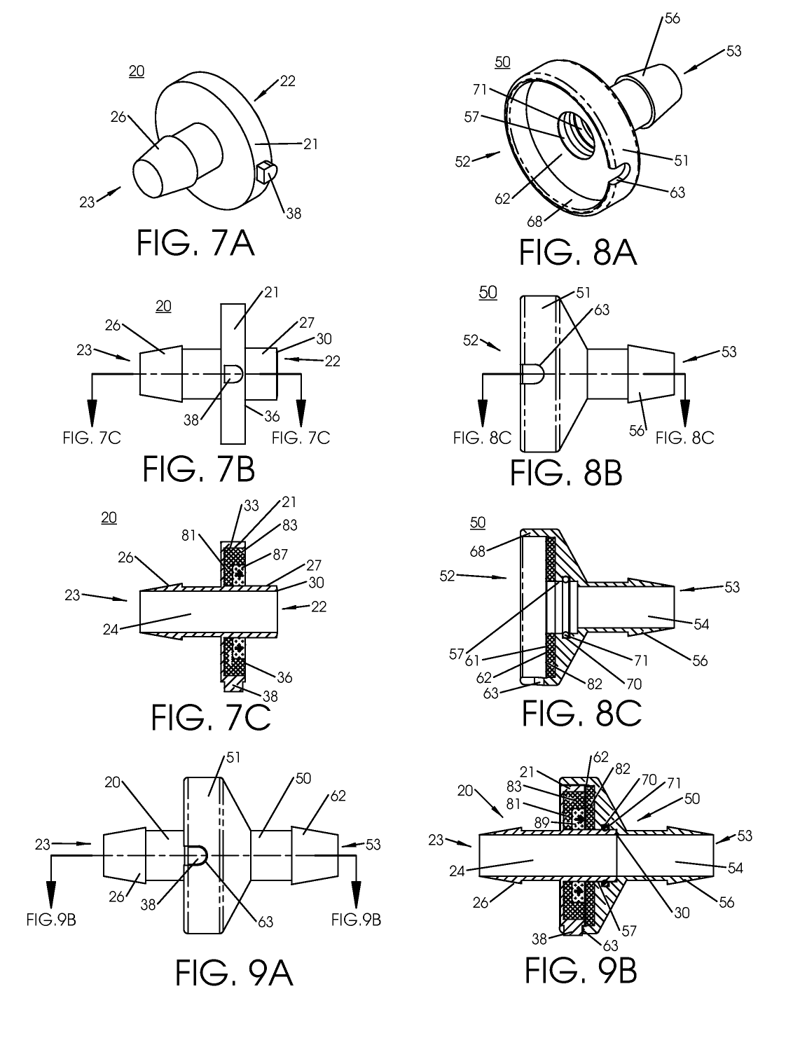

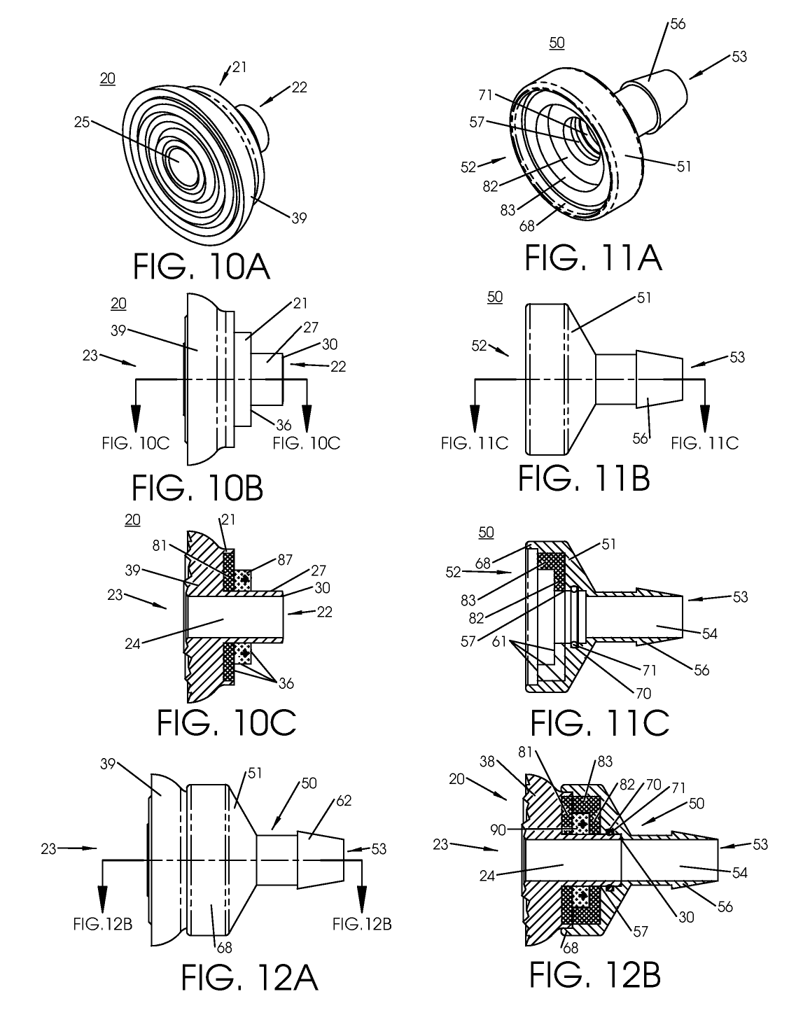

Shown in FIGS. 7A-9B, a third preferred embodiment of the present invention is illustrated. FIGS. 7A-7C illustrates male element 20, FIGS. 8A-8C illustrates female element 50, and FIGS. 9A-9B shows male element 20 and female element 50 in an attached configuration according to this third preferred embodiment. The third preferred embodiment maintains much of the same nomenclature as previous embodiments but exhibits several differences. Although similar to the previous embodiment in the interfacing plug and socket geometry of plug member 27 and receiving cavity 57. This third preferred embodiment illustrates a different configuration of the magnetic elements within male armature 21 of male element 20 and further provides a tab 38 and keyway 63 interface for maintaining a predetermined radial orientation when male element 20 is attached within female element 50. It should be understood that the aforementioned “predetermined” radial orientation may be considered fixed in the sense that the configuration is biased in an intended radial orientation.

Male armature 21 of male element 20 includes central permanent magnet ring 89 with outer ferromagnetic ring segment 83 and back ferromagnetic ring segment 81 surrounding it on two sides such that the addition of front ferromagnetic ring segment 82 in proximity to central permanent magnet ring 89 as anterior end 22 and anterior end 52 are fitted together causes a substantially closed low impedance flux path around central permanent magnet ring 89. In this case the flux path provided is through a single loop of ferromagnetic material surrounding central permanent magnet ring 89 on three sides and not a double loop of ferromagnetic material as the case when a permanent magnet is surrounded on all sides.

Also according to the third preferred embodiment tab 38 is displaced on male armature 21 for fitting within keyway 63 of shroud portion 68. As shown in FIG. 9A, tab 38 of male element 20 fits within keyway 63 of female element 50 in the assembled configuration whereas male element 20 is maintained in a fixed orientation with respect to female element 50. Depending on the application it may be preferred to enable relative rotation along the axis of male element 20 and female element 50 so as to not transmit any torque through the coupling device or if necessary to maintain a fixed radial orientation, a mechanical means shown in this third preferred embodiment can be utilized.

Shown in FIGS. 10A-12B, a fourth preferred embodiment of the present invention is illustrated. FIGS. 10A-10C illustrates male element 20 which is integral with pump housing 39, FIGS. 11A-11C illustrates female element 50, and FIGS. 12A-12B shows male element 20 and female element 50 in an attached configuration according to this fourth preferred embodiment. This fourth preferred embodiment maintains much of the same nomenclature as previous embodiments. Posterior end 23 of male element 20 includes barb fitting 26 while posterior end 53 of female element 50 includes barb fitting 56. Posterior end 23 is shown as a broken section and represents the end portion of pump housing, which is either the inflow or outflow portion for flow through conduit 24. According to this embodiment, the coupling device is adapted for the advantageous attachment of a conduit 54 to a conduit 34 within a pump housing 39.

Male armature 21 of male element 20 includes bottom magnetized ring 90 and back ferromagnetic ring segment 81. Female armature 51 of female element 50 includes front ferromagnetic ring segment 82 and outer ferromagnetic ring segment 83 as shown. Also unique to this configuration as compared to the first three preferred embodiments is that outer ferromagnetic ring segment 83 is displaced in female element 50 rather than male element 20 and parting surface 36 steps between two surfaces. Accordingly only two magnetic elements back ferromagnetic ring segment 81 and central permanent magnet ring 89 are displaced in male element 20 allowing for anterior end 22 to have a very low profile. Alternatively, according to the invention, bottom magnetized ring 90 could also be displaced in female armature 51 of female element 50 where as male element 20 which is actually a pump would include no permanent magnets to interact with other structures or devices when female element 50 is not attached.

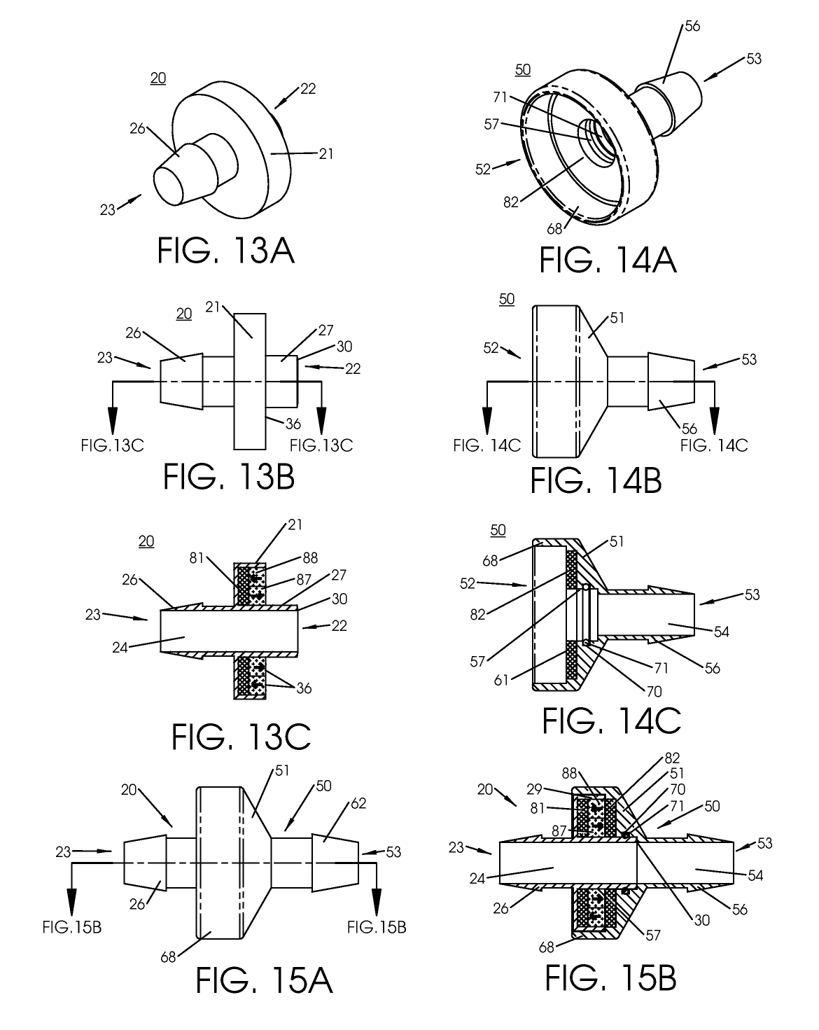

Shown in FIGS. 13A-15B, a fifth preferred embodiment of the present invention is illustrated. FIGS. 13A-13C illustrates male element 20, FIGS. 14A-14C illustrates female element 50, and FIGS. 15A-15B shows male element 20 and female element 50 in an attached configuration according to this fifth preferred embodiment. This fifth preferred embodiment maintains much of the same nomenclature as previous embodiments. In this case male armature 21 includes back ferromagnetic ring segment 81 and two permanent magnet rings; inner permanent magnet ring 87 and outer permanent magnet ring 88. Outer permanent magnet ring 88 is positioned on the outside of inner permanent magnet ring 87 and is arranged so that the axial polarity is opposite to inner permanent magnet ring 87. Female armature 51 of female element 50 simply includes front ferromagnetic ring segment 82 such that when anterior end 22 of male element 20 is fitted within anterior end 52 of female element 50, front ferromagnetic ring segment 82 is attracted to inner permanent magnet ring 87 and outer permanent magnet ring 88 as a magnetically-susceptible material that provides a substantially closed low impedance flux loop. The advantage of this arrangement is that the retention force will be much higher than if inner permanent magnet ring 87 or outer permanent magnet ring 88 was a ferromagnetic material rather than a permanent magnet.

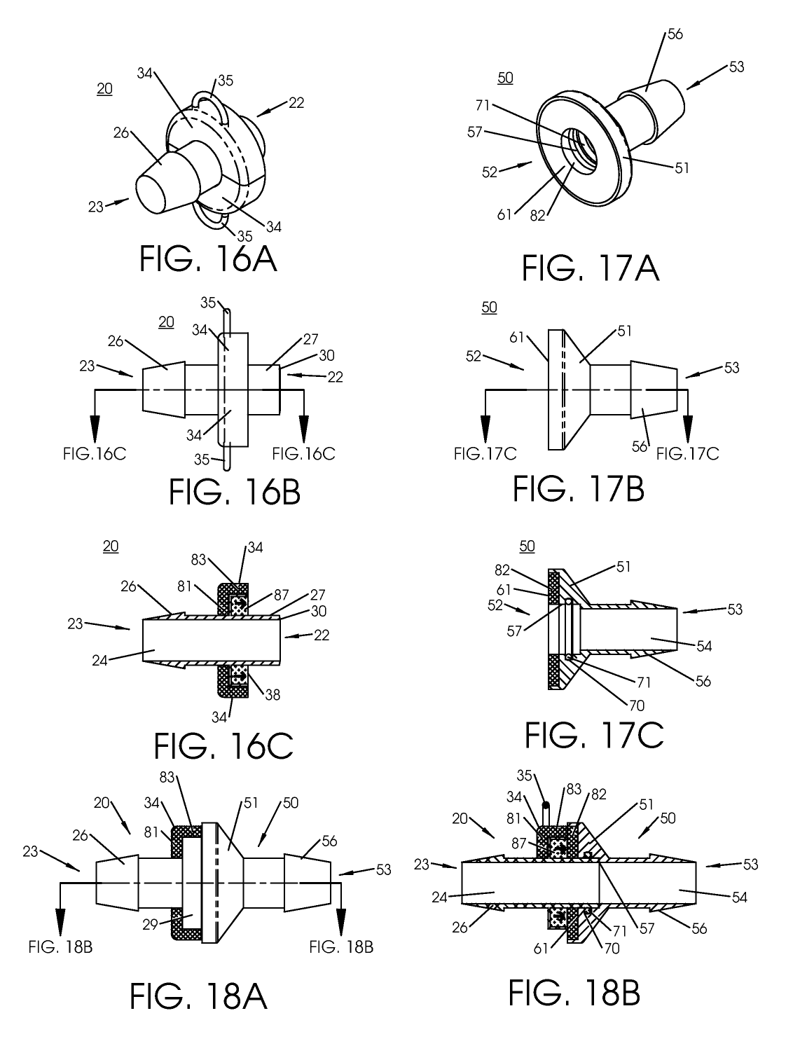

Shown in FIGS. 16A-18B, a sixth preferred embodiment of the present invention is illustrated. FIGS. 16A-16C illustrates male element 20 with Ferromagnetic collar 34 attached thereon, FIGS. 17A-17C illustrates female element 50, and FIGS. 18A-18B shows male element 20, Ferromagnetic collar 34 and female element 50 in an attached configuration according to this sixth preferred embodiment. This sixth preferred embodiment maintains much of the same nomenclature as previous embodiments.

Inner permanent magnet ring 87 is displaced near anterior end 22 of male element 20 as a magnetic material which is affixed to male element 20. Ferromagnetic collar 34 includes back ferromagnetic ring segment 81 and outer ferromagnetic ring segment 83 and is adapted to reside around two sides of inner permanent magnet ring 87. Female armature 51 includes front ferromagnetic ring segment 82 and works with male element 20 and Ferromagnetic collar 34 when these components are in an assembled configuration. Ferromagnetic collar 34 is removable from male element 20 and is of two or more segments which accumulate to surround the outside of inner permanent magnet ring 87. As shown in FIGS. 18A-18B, a single ferromagnetic collar 34 is coupled to male element 20 wherein male element 20 is magnetically coupled to front ferromagnetic ring segment 82. Around the half where ferromagnetic collar 34 is extent, a substantially closed loop of a low impedance flux path is provided. However, on the portion of male element 20 where Ferromagnetic collar 34 is not extent, a ferromagnetic flux path is not provided around inner permanent magnet ring 87. The lack of a Ferromagnetic collar 34 dramatically reduces the retention force of the magnetic coupling device.

The particular advantage of this embodiment is that a very large breakaway force can be designed into the coupling device as is necessary to withstand internal pressure and operational loads as required for the application. Without detachable ferromagnetic collar 34, a high breakaway force would then make it much more difficult to detach male element 20 from female element 50 when it is intended to do so. By using ones hands to pull apart male element 20 and female element 50 the force required to do so could be excessive and prohibitive unless a means of incrementally splitting the armature is provided. The components that contribute to the closed loop flux path can be increased to a greater of number pieces to reduce disassemble loads such as provided by this sixth preferred embodiment. Utilizing two or more Ferromagnetic collar 34 enables maximum flux coupling but allows a person to gradually reduce the break away force of male element 20 with female element 50 by removing one ferromagnetic collar segment 34 at a time as the force required to remove each ferromagnetic collar segment 34 is less than the force required to extract female element 50 from male element 20 with all segments of ferromagnetic collar 34 attached. Lug 35 is provided on each Ferromagnetic collar 34 to facilitate removal of each ferromagnetic collar segment 34.

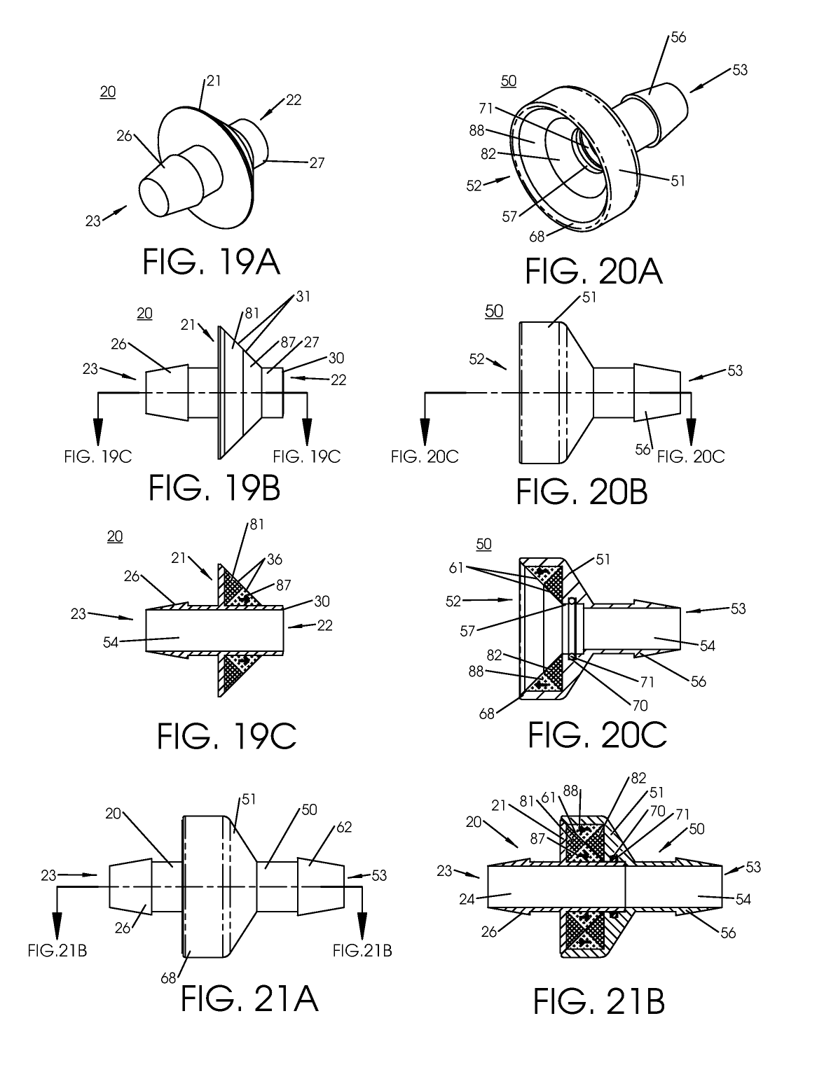

Shown in FIGS. 19A-21B, a seventh preferred embodiment of the present invention is illustrated. FIGS. 19A-19C illustrates male element 20, FIGS. 20A-20C illustrates female element 50, and FIGS. 21A-21B shows male element 20 and female element 50 in an attached configuration according to this seventh preferred embodiment. This seventh preferred embodiment maintains much of the same nomenclature as previous embodiments. Unlike prior embodiments male armature 21 of male element 20 includes inner permanent magnet ring 87 and back ferromagnetic ring segment 81 which form a conical geometry to interface with female armature 51 of female element 50 including front ferromagnetic ring segment 82 and outer permanent magnet ring 88.

As distinct from the proceeding embodiments, magnetic materials of male armature 21 and female armature 51 assume a triangular cross section rather than a rectangular cross section. This arrangement maintains the premise of the invention to maximize attractive force of male element 20 and female element 50 by providing magnetic coupling of flux carried through a high susceptibility flux path of a substantially closed loop. Inner permanent magnet ring 87 and outer permanent magnet ring 88 have magnetic poles oriented in the opposite axial direction. As shown in the cross-sectional view of FIG. 21B, male armature 21 B includes magnetic materials of back ferromagnetic ring segment 81, front ferromagnetic ring segment 82, inner permanent magnet ring 87 and outer permanent magnet ring 88 that form a substantially closed loop male armature 21 of male element 20 is brought into close proximity with female armature 51 of female element 50 along parting surface 61.

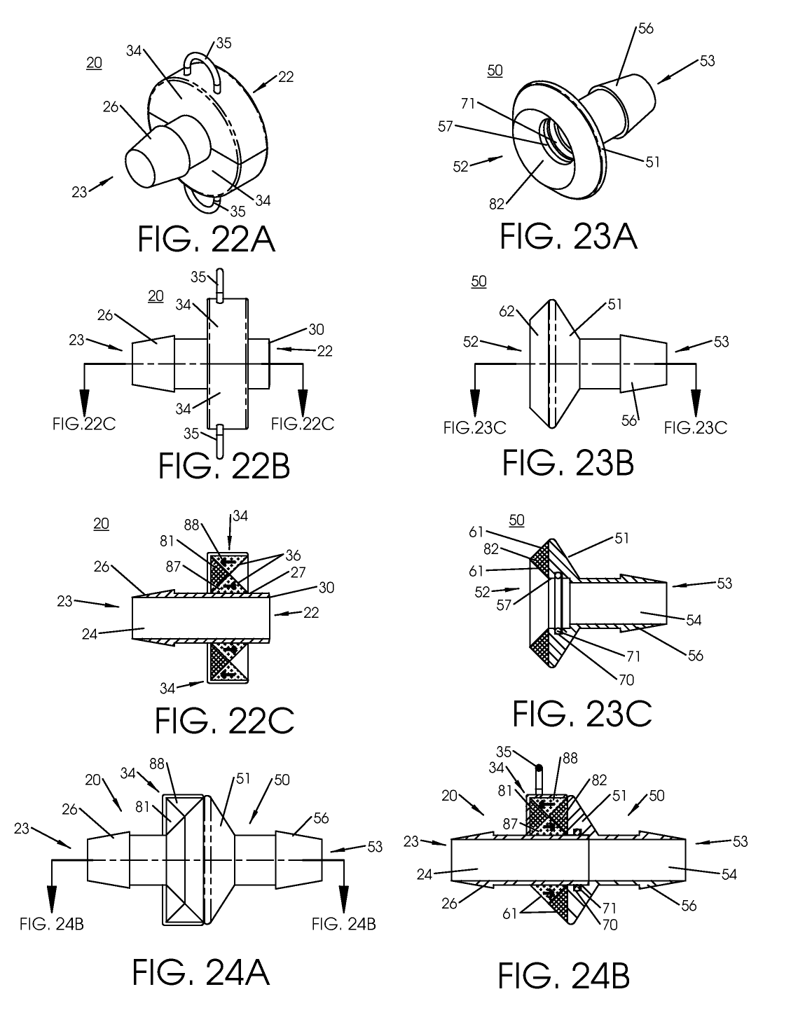

Shown in FIGS. 22A-24B, an eighth preferred embodiment of the present invention is illustrated. FIGS. 22A-22C illustrates male element 20 with ferromagnetic collar 34 attached thereon, FIGS. 23A-23C illustrates female element 50, and FIGS. 24A-24B shows male element 20, ferromagnetic collar 34 and female element 50 in an attached configuration according to this eighth preferred embodiment. This embodiment maintains much of the same nomenclature as previous embodiments. Ferromagnetic collar 34 includes back ferromagnetic ring segment 81 and outer permanent magnet ring 88. Ferromagnetic collar 34 can be removed form male element 20 during disassembly of the coupling device as shown in FIG. 24B. Accordingly, female element 50 can be more easily separated from male element 20 as ferromagnetic collar 34 are removed whereby the breakaway force of male element 20 with respect to female element 50 is diminished with the removal of two or more Ferromagnetic collar 34 consistent with the rationale of the sixth preferred embodiment corresponding to FIGS. 16A-18B.

In this embodiment, back ferromagnetic ring segment 81, front ferromagnetic ring segment 82, inner permanent magnet ring 87 and outer permanent magnet ring 88 is of a triangular cross-section consistent with the seventh preferred embodiment corresponding to FIGS. 9A-21B. Since ferromagnetic collar 34 couples to male element 20 and female element 50 along a parting surface 36 that is of a conical geometry, ferromagnetic collar 34 should be less difficult to remove from male element 20 when coupled to female element 50. This is because a moment can be applied to ferromagnetic collar 34 via lug 35 to facilitate a pivoting action in extracting two or more ferromagnetic collar 34 from the magnetically coupled male element 20 and female element 50.

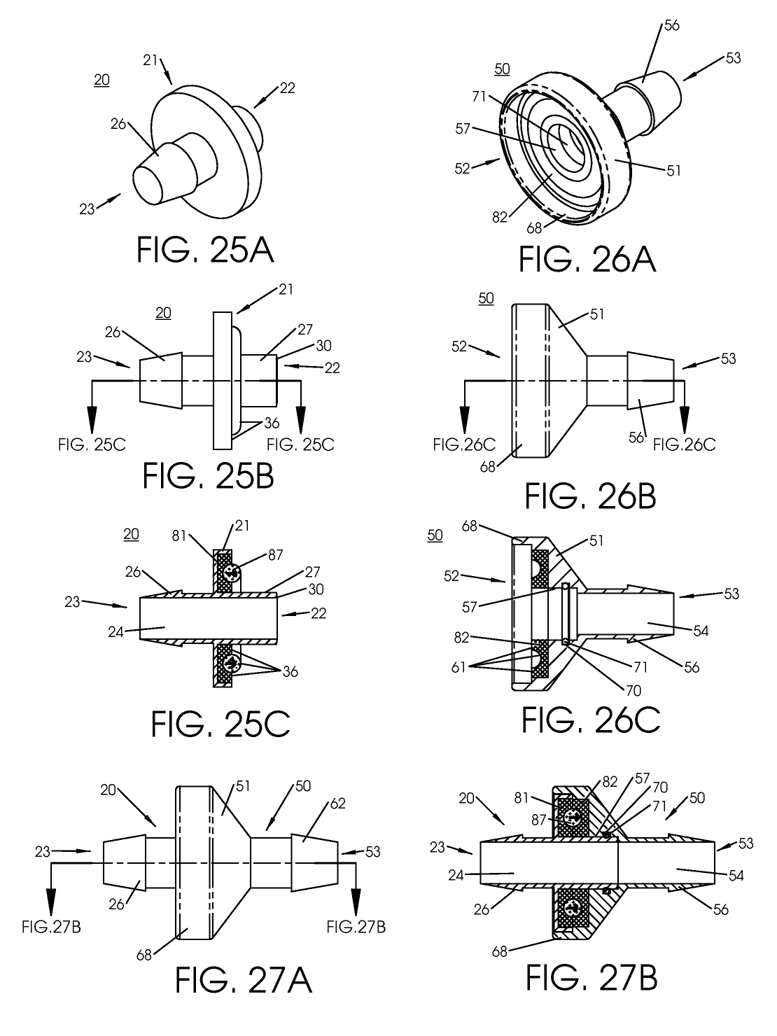

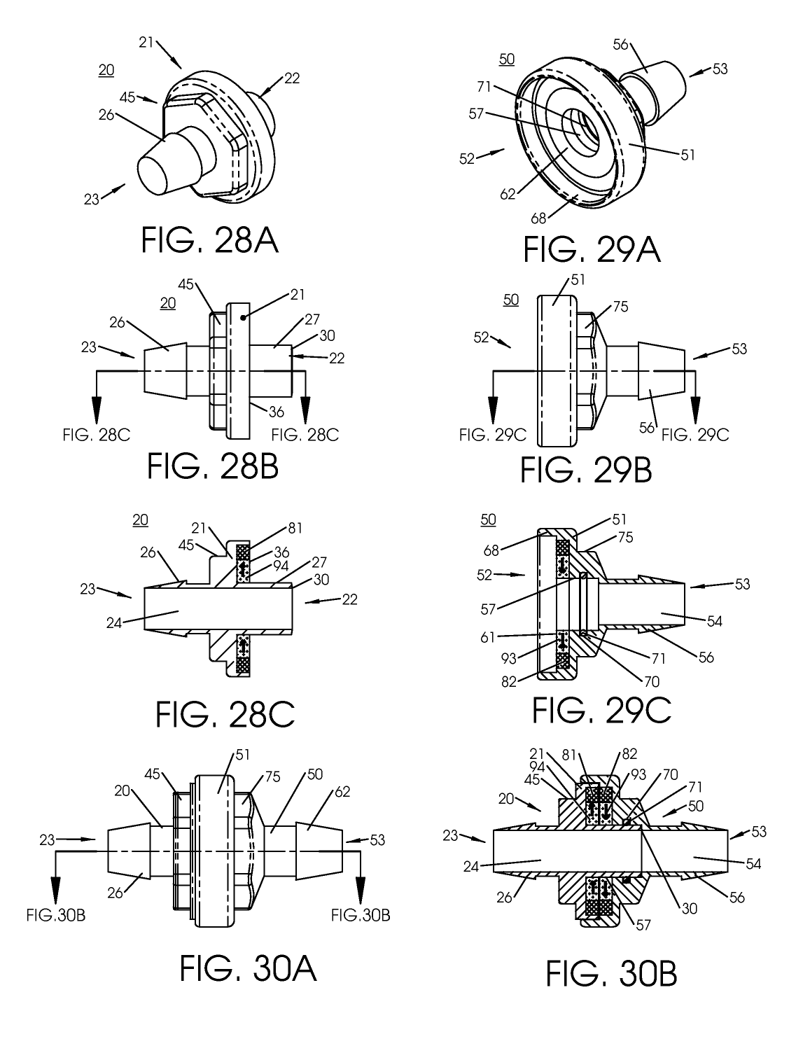

Shown in FIGS. 25A-27B, a ninth preferred embodiment of the present invention is illustrated. FIGS. 25A-25C illustrates male element 20, FIGS. 26A-26C illustrates female element 50, and FIGS. 27A-27B shows male element 20 and female element 50 in an attached configuration according to this ninth preferred embodiment. The ninth preferred embodiment maintains much of the same nomenclature as previous embodiments. Unlike prior embodiments male armature 21 of male element 20 includes inner permanent magnet ring 87 and back ferromagnetic ring segment 81. Inner permanent magnet ring 87 is of a circular cross-sectional geometer whereby back ferromagnetic ring segment 81 surrounds the back half of inner permanent magnet ring 87. Female armature 51 of female element 50 includes front ferromagnetic ring segment 82 which is adapted for close interfitting with back ferromagnetic ring segment 81 and inner permanent magnet ring 87 along parting surface 36 when anterior end 22 of male element 20 is coupled to anterior end 52 of female element 50 as shown in FIG. 27B.

Shown in FIGS. 28A-30B, a tenth preferred embodiment of the present invention is illustrated. FIGS. 28A-28C illustrates male element 20, FIGS. 29A-29C illustrates female element 50, and FIGS. 30A-30B shows male element 20 and leading edge 30 in an attached configuration according to this tenth preferred embodiment. The tenth preferred embodiment maintains much of the same nomenclature as previous embodiments. Male armature 21 of male element 20 includes diametrically magnetized ring 94 and back ferromagnetic ring segment 81. Unlike previous embodiments a diametrically magnetized ring 94 is provided that is not magnetized in the axial direction but rather is diametrically magnetized. Female armature 51 of female element 50 includes diametrically magnetized ring 93 and shroud portion 68.

As shown in the assembled cross-sectional view of FIG. 30B, male armature 21 couples with female armature 51 in such a manner that diametrically magnetized ring 93 and diametrically magnetized ring 94 are in a fixed radial orientation such that the diametric magnetic poles of diametrically magnetized ring 93 and diametrically magnetized ring 94 are opposite. Accordingly this tenth preferred embodiment provides the advantage of a magnetic means of securing male element 20 to female element 50 in a fixed radial orientation. Thus mechanical means of preventing rotation of male element 20 with respect to male armature 21 is not necessary to counteract an applied torque under design conditions. In this case the substantially closed low impedance flux loop is not symmetrical about the central axis of the conduit 24 and conduit 54 and is characterized with symmetry about a single central plane whereas the flux is at least partially transmitted in a radial path through back ferromagnetic ring segment 81 and front ferromagnetic ring segment 82.

A unique aspect of this development is that torque can be applied to release the coupling device. Male armature 21 of male element 20 and female armature 51 of female element 50 each respectively include hex interface 45 and hex interface 75 for engagement with a conventional wrench. Alternatively, the device may include other features on the exterior to interface with a wrench or other type of specialized tool allowing one to apply a counter-acting torque between male element 20 and female element 50. Under an applied torque via hex interface 45 and hex interface 75, the coupling device would resist relative rotation between male element 20 and female element 50 until the applied torque is sufficiently large to rotate male element 20 with respect to female element 50 causing male element 20 and female element 50 to disconnect as the north pole diametrically magnetized ring 94 is brought into the same radial orientation as the north pole of diametrically magnetized ring 93. Male element 20 need only experience greater than hex interface 45 degrees of rotation with respect to female element 50 for male armature 21 to be repelled from female armature 51. It is often more ergonomic to apply a torque to release a device than an axial load. The magnetic coupling of this tenth preferred embodiment is so adapted to be detachable without having to apply an excessive axial load by pulling apart male element 20 and female element 50.

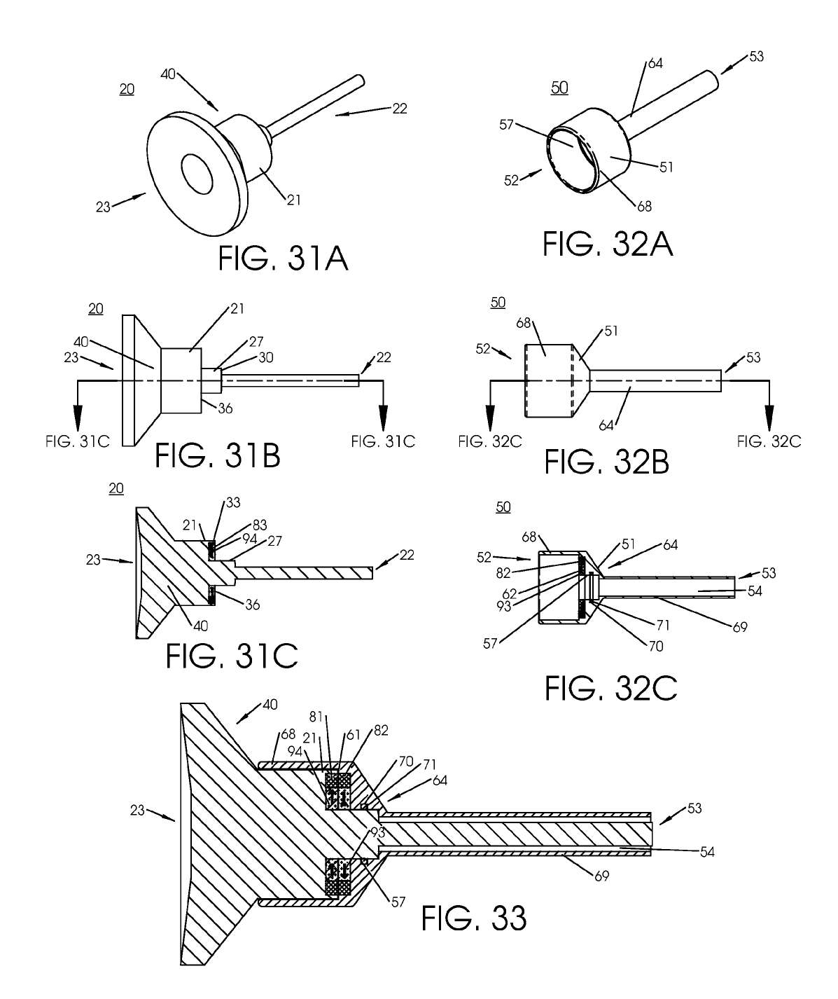

Shown in FIGS. 31A-33, an eleventh preferred embodiment of the present invention is illustrated. FIGS. 31A-31C illustrates male element 20, FIGS. 32A-32C illustrates female element 50, and FIG. 33 shows male element 20 and female element 50 in an attached configuration according to this eleventh preferred embodiment. In this case male element 20 is an endoscope optical system including elongated anterior end 22. Female element 50 is a sheath 64 system with a tube section 69 wherein conduit 54 adapted for providing a conduit for the passage of anterior end 22 of endoscope 40 toward posterior end 53 of female element 50. Sheath female element 50 is provided to protect endoscope male element 20 from damage during use and may also be adapted to provide a flow passage from anterior end 52 to posterior end 53 of female element 50.

Endoscope 40 includes male armature 21, plug member 27 that provides the basis for coupling with female armature 51, receiving cavity 57, shroud portion 68, o-ring groove 70, and o-ring seal 71 of female element 50. Male armature 21 of male element 20 includes back ferromagnetic ring segment 81 and diametrically magnetized ring 94 while female armature 51 of female element 50 includes front ferromagnetic ring segment 82 and diametrically magnetized ring 93 whereby device is magnetically coupled in a similar manner to the tenth preferred embodiment of FIGS. 28A-30B. As shown in FIG. 33, diametrically magnetized ring 93 and diametrically magnetized ring 94 are coupled in a particular radial orientation such that unlike poles attract. Detachment of endoscope male element 20 with respect to sheath female element 50 is facilitated by twisting posterior end 23 of male element 20 with respect to female element 50 and causing a repulsion of male armature 21 and female armature 51.

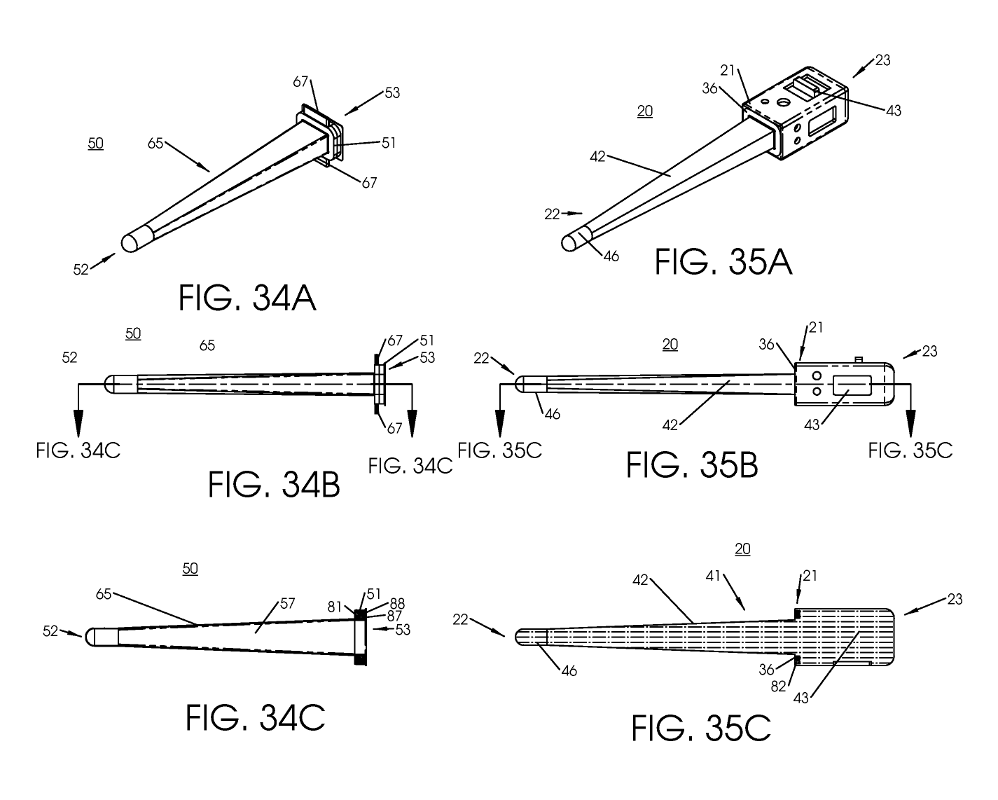

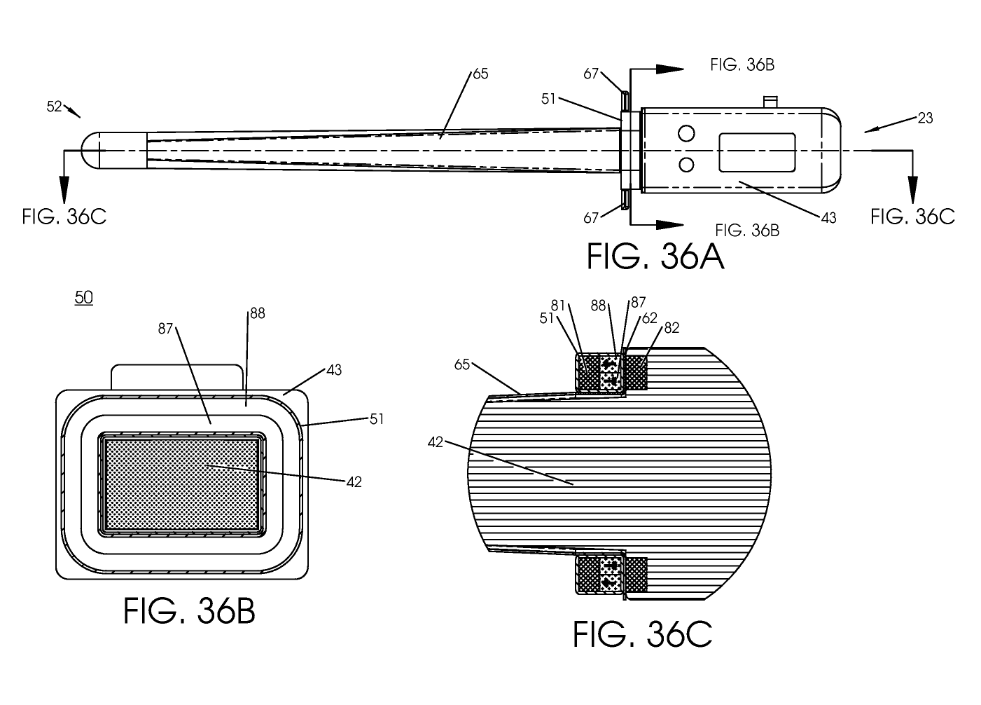

Shown in FIGS. 34A-36C, a twelfth preferred embodiment of the present invention is illustrated. FIGS.34-34C illustrates male element 20, FIGS. 35A-35C illustrates female element 50, and FIGS. 36A-36C show male element 20 and female element 50 in an attached configuration according to this twelfth preferred embodiment. In this case male element 20 is a probe that is adapted to magnetically couple with female element 50 which is a detachable unit for covering and protecting recess face 46 and elongated probe 42 of male element 20. Probe male element 20 could be of any type of known probe with an elongated body to gather information from a distant end such as a thermometer. Accordingly female element 50 will serve a protective attachment in which a conduit is provided for receiving anterior end 22 of male element 20.

Male element 20 includes control, process, and readout section 43 at posterior end 23. Elongated probe 42 extends from control, process, and readout section 43 toward anterior end 22. Elongated probe 42 terminates at recess face 46 at anterior end 22. Parting surface 36 is provided at the transition between control, process, and readout section 43 and elongated probe 42. Front ferromagnetic ring segment 82 is provided within male armature 21 for attractive coupling to female armature 51 of female element 50. Female element 50 includes female armature 51 at posterior end 53 with cover 65 affixed to and extending from posterior end 53 toward anterior end 52. Cover 65 is a hollow receiving cavity 57 adapted to receive elongated probe 42. Female armature 51 includes back ferromagnetic ring segment 81, outer permanent magnet ring 88, and central permanent magnet ring 89 as is best shown in FIG. 36C. Back ferromagnetic ring segment 81, front ferromagnetic ring segment 82 inner permanent magnet ring 87 and outer permanent magnet ring 88 work together to form a flux circuit of a substantially closed low-impedance flux loop when brought into proximity. Gripping tabs 67 is provided near female armature 51 of female element 50 for the removal of sensor cover from sensor.

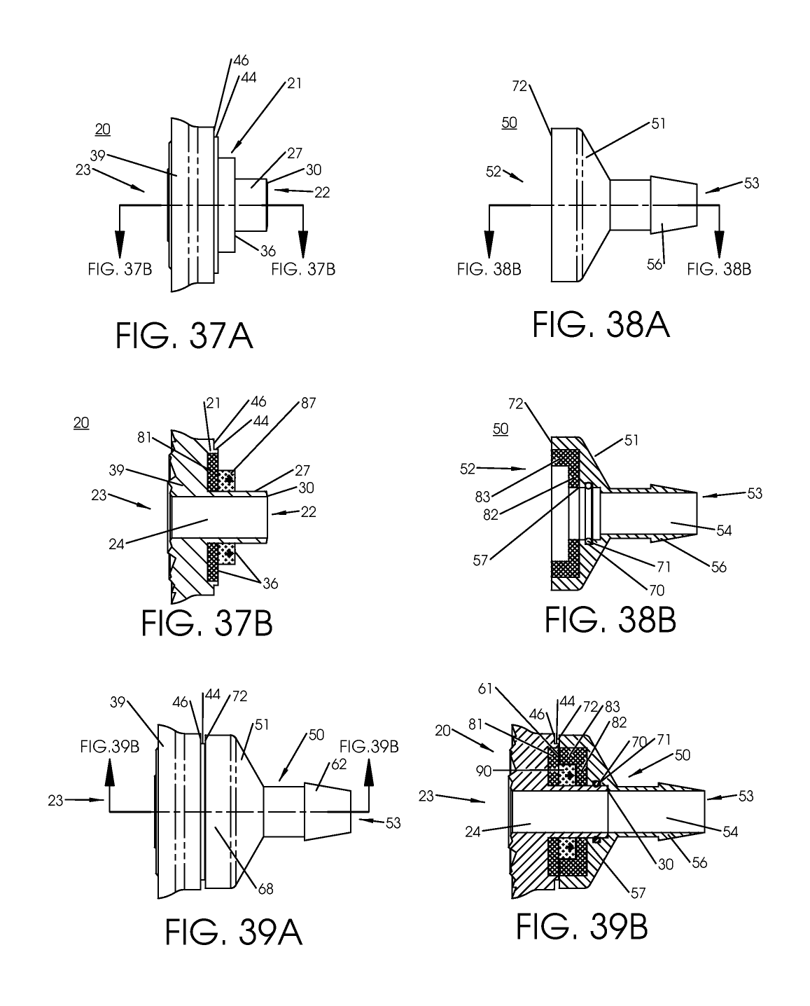

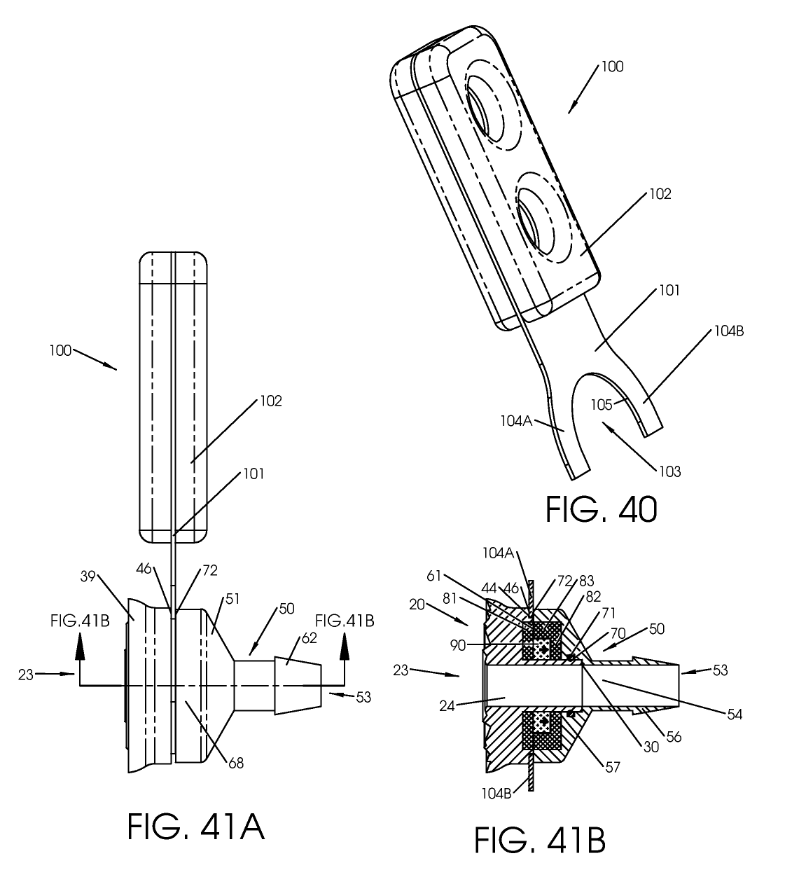

Shown in FIGS. 37A-41B, a thirteenth preferred embodiment of the present invention is illustrated. FIGS. 37A-37B illustrates male element 20, FIGS. 38A-38B illustrates female element 50, and FIGS. 39A-39B show male element 20 and female element 50 in an attached configuration according to this thirteenth preferred embodiment. FIGS. 40 illustrates pry/wedge tool accessory 100 as it pertains to this embodiment and FIGS. 41A-41B shows pry/wedge tool accessory 100 as it is inserted between male element 20 and to female element 50 in an attached configuration.

Referring to FIGS. 37A-39B, male element 20 and female element 50 disclosed is nearly identical to the forth preferred embodiment of FIGS. 10A-12B with the exception that male element 20 further includes recess 44 adapted to provide a separation between recess face 46 and parting face 72 for insertion of a pry/wedge tool accessory as shown in FIG. 40. All other nomenclature remains the same. As shown in FIG. 40, pry/wedge tool accessory 100 includes plate 101 with slot 103 at a first operational end and handle 102 for gripping with ones hands. Around slot 103, plate 101 is characterized with arm 104A and arm 104B extending around internal radius 105. Internal radius 105 of pry/wedge tool accessory 100 is sized to be nearly equivalent to the diameter associated with recess 44 of male element 20.

Insertion of pry/wedge tool accessory 100 into recess 44 between hex interface 45 of male element 20 and parting face 72 of female element 50 is illustrated in FIGS. 41A-41B. The width of plate 101 is sized to slide between parting face 46 and parting face 72 when inserted perpendicular to the symmetrical axis of male element 20 and female element 50. Seen in FIG. 41B arm 104A and arm 104B of pry/wedge tool accessory 100 intersect recess 44 as necessary for utilizing pry/wedge tool accessory 100 to separate male element 20 from female element 50. Separation of the coupling device is achieved by gripping handle 102 and pushing or pulling along the axis of male element 20 and female element 50. The applied load to handle 102 transfers a moment to arm 104A and arm 104B which bears against parting face 46 of male element 20 and parting face 72 of female element 50 to essentially pry/wedge male element 20 and female element 50 apart. The applied load required for separating male element 20 and female element 50 utilizing pry/wedge tool accessory 100 is to be substantially less than what would be required in providing a direct pulling action to male element 20 and female element 50 without the advantage of the moment from applying pry/wedge tool accessory 100. Accordingly, the coupling of the present invention provides a means to attain high retention via a magnetic interface of minimum size and profile while also enabling the advantageous use of accessory tools or features to facilitate detachment of the coupling device with applied forces substantially less than the high axial breakaway force intended for retention of the coupling device.

Although the present invention has been described herein with reference to a particular embodiment, it will be understood that this description is exemplary in nature and is not considered as a limitation on the scope of the invention. The scope and spirit of the present invention is therefore only limited by the appended claims and the reasonable interpretation thereof:

1. A magnetic coupling device for providing removable-attachment of a conduit comprising;
a male element and a female element and at least one internal conduit within; said male element comprising an anterior end and a posterior end; said anterior end of said male element comprising a first magnetic armature; said first magnetic armature comprising at least one magnetic material forming a substantially closed ring around the periphery of said at least one conduit; said female element comprising an anterior end and a posterior end; said anterior end comprising of said female element comprising a second magnetic armature near said anterior end; said second magnetic armature comprising at least one magnetic material forming a substantially closed ring around the periphery of said at least one conduit;
said anterior ends of said male element and said female element being adapted for interfitting in a plug and socket type arrangement whereas said first magnetic armature is magnetically attracted to said second magnetic armature when said anterior end of said male element is fitted within said anterior end of said female element; said first magnetic armature and said second magnetic armature adapted to attract together to form a magnetic circuit; said magnetic circuit comprising ferromagnetic material and at least one permanent magnet.

2. The magnetic coupling device of claim 1, whereas said magnetic circuit includes at least one low-impedance flux path of a substantially closed loop.

3. The magnetic coupling device of claim 2, whereas said first magnetic armature of said male element comprises at least one permanent magnet forming a substantially closed ring around the periphery of said at least one conduit.

4. The magnetic coupling device of claim 3, whereas said permanent magnet of said male element is closely surrounded by ferromagnetic magnetic material on at least three sides when said male element is attached to said female element.

5. The magnetic coupling device of claim 4, whereas said second magnetic armature of said female element comprises at least one permanent magnet forming a substantially closed ring around the periphery of said at least one conduit.

6. The magnetic coupling device of claim 5, whereas said permanent magnet of said female element is closely surrounded by ferromagnetic magnetic material on at least three sides when anterior end of said male element is fitted with anterior end of said female element.

7. The magnetic coupling device of claim 6, whereas said first magnetic armature of said male element and said second magnetic armature of said female element both comprise at least one permanent magnet forming a substantially closed ring around the periphery of said at least one conduit.

8. The magnetic coupling device of claim 7, whereas said permanent magnet of said male element and said permanent magnet of said female element are axially magnetized in opposing directions and are closely surrounded by ferromagnetic magnetic material on at least two sides when anterior end of said male element is fitted with anterior end of said female element.

9. The magnetic coupling device of claim 8, wherein said ferromagnetic magnet material of said magnetic circuit is of sufficient magnetic permeability and cross-sectional area is not saturated when said male element is attached to said female element such that no significant flux leakage occurs.

10. The magnetic coupling device of claim 9, whereas said first and second magnetic armatures are substantially closed rings, said substantially closed rings being of a predetermined geometry selected from a group consisting of circular geometry and rectangular geometry.

11. (canceled)

12. The magnetic coupling device of claim 10, whereas said first armature of said male element further comprises a magnetic collar;
said magnetic collar being sectioned in two or more segments of a magnetic material;
said magnetic collar adapted for residing in an interfitting position on said first armature where as said magnetic collar cooperates with said first magnetic armature of said male element and said second magnetic armature of said female element to form a substantially closed magnetic circuit when the anterior end of said male element is fitted with the anterior end of said female element.

13. The magnetic coupling device of claim 12, said magnetic collar configured to facilitate displacement of said magnetic collar from said first magnetic armature by reducing the extent of high permeability flux path through said armature and causing sufficient flux leakage in providing for detachment of said male element from said female element with lesser break away force than would otherwise be required if there was substantially no flux leakage provided by the complete interfitting assembly of said magnetic collar, said male element, and said female element.

14. The magnetic coupling device of claim 13, whereas said first armature of said female element further comprises a magnetic collar; said magnetic collar being sectioned in two or more segments of a magnetic material; said magnetic collar adapted for residing in an interfitting position on said second armature where as said magnetic collar cooperates with said first magnetic armature of said male element and said second magnetic armature of said female element to form a substantially closed magnetic circuit when the anterior end of said male element is fitted with the anterior end of said female element.

15. The magnetic coupling device of claim 14, said magnetic collar configured to facilitate displacement of said magnetic collar from said second magnetic armature by reducing the extent of high permeability flux path through said armature and causing sufficient flux leakage in providing for detachment of said male element from said female element with lesser break away force than would otherwise be required if there was substantially no flux leakage provided by the complete interfitting assembly of said magnetic collar, said male element and said female element.

16. The magnetic coupling device of claim 15, further comprising a pry/wedge tool accessory adapted to assist the detachment of said male and female elements; said pry/wedge tool accessory in the form of an elongated body with gripping end and an operative end; said male and female elements further comprising a separation-groove at the parting seam near their anterior end; separation-groove adapted to receive said operative end of said pry/wedge tool accessory, whereas said pry/wedge tool accessory provides a moment arm for assisting a person in facilitating detachment of said male and female elements when applying axial load on said handle end of said pry/wedge tool that is lower than the applied forces that would be required if said male and female elements were manually pulled apart.

17. The magnetic coupling device of claim 16, further comprising a tab and keyway adapted to constrain said male element in a locked radial orientation with respect to said female element when anterior end of said male element is fitted with anterior end of said female element.

18. The magnetic coupling device of claim 17, said first magnetic armature of said male element comprising a first permanent magnet and said second magnetic armature of said female element comprising a second permanent magnet;
said first permanent magnet and said second permanent magnet both diametrically magnetized and forming a substantially closed ring around the periphery of said at least one conduit whereas diametric magnetization of both said first permanent magnet and said second permanent magnet cause male element to be held in a predetermined radial orientation with respect to said female element when said male element is inserted therein.

19. The magnetic coupling device of claim 18, said male and said female element both including geometry on the exterior of said male and said female armatures; said geometry for facilitating counter-acting twisting action; said geometry adapted to facilitate detachment of said male element from said female element by forcing like poles of said first permanent magnet of said male element toward like poles of said second permanent magnet of said female element whereas repulsion associated with altered radial alignment causes said male element to detach from said female element.

20. The magnetic coupling device of claim 19, said male or said female element further comprising an elastomeric seal; said elastomeric seal adapted to provide a compression seal against a plug face of said male element when said male element is attached to said female element whereas said elastomeric seal provides an air-tight seal to said at least one conduit.

21. The magnetic coupling device of claim 20, said male element further comprising a first tube fitting at its posterior end, said female element further comprising a second tube fitting at its opposing end, whereas said magnetic coupling devices is adapted to provide a removably-interfitting coupling between two tubes.

22. The magnetic coupling device of claim 21, said male or said female element further comprising a fluid processing device at one opposed end, said male or female element further comprising a tube fitting at the other opposing end, whereas said magnetic coupling devices is adapted to provide a removably-interfitting fluid coupling between a tube and a fluid processing device.

23. The magnetic coupling device of claim 22, said first magnetic armature of said male element further comprising a substantially thin layer of protective material surrounding said magnetic material of said first magnetic armature, whereas said protective material is adapted to cover said magnetic material.

24. The magnetic coupling device of claim 23, said second magnetic armature of said female element further comprising a substantially thin layer of protective material surrounding said magnetic material of said second magnetic armature, whereas said protective material is adapted to cover said magnetic material.

25. The magnetic coupling device of claim 24, said protective material adapted to provide mechanical protection to said magnetic material.

26. The magnetic coupling device of claim 25, said protective material adapted to insulate said magnetic material from exposure to a harsh environment of chemicals.

27. The magnetic coupling device of claim 26, said protective material adapted to insulate said magnetic material from exposure to said at least one conduit or the outside environment for protecting said at least one conduit or said outside environment from contamination by said magnetic material.

28. The magnetic coupling device of claim 20, whereas said at least one conduit is a fluid conduit adapted for internal fluid communication between said male element and said female element.

29. The magnetic coupling device of claim 20, whereas said at least one conduit is a gas conduit adapted for internal gas communication between said male element and said female element.

30. The magnetic coupling device of claim 20, whereas said at least one conduit is a vacuum conduit adapted for transferring an internal vacuum between said male element and said female element.

31. The magnetic coupling device of claim 20, whereas said at least one conduit is adapted for providing internal mass transfer of solid or semisolid particles from one opposed end to the other.

32. The magnetic coupling device of claim 20, whereas said at least one conduit is adapted for providing the internal bulk transfer of solid or semisolid particles from one opposed end to the other.

33. The magnetic coupling device of claim 20, whereas said at least one conduit is adapted for providing a working channel for the internal transfer of the operative end of an elongated object or instrument from one opposed end toward the other.

34. The magnetic coupling device of claim 20, whereas said at least one conduit is adapted for providing protective covering to the operative end of an elongated object or instrument attached therein.
